(19) United States
(12) Patent Application Publication
(10) Pub. No.: US 2019/0176917 A1
(43) Pub. Date: Jun. 13, 2019

(54) WHEELIE GUARD

(71) Applicants: Peter J. RICE, Vancouver (CA); Adam RABEDA, Vancouver (CA)

(72) Inventors: Peter J. RICE, Vancouver (CA); Adam RABEDA, Vancouver (CA)

(21) Appl. No.: 16/181,282

(22) Filed: Nov. 5, 2018

Related U.S. Application Data
(60) Provisional application No. 62/581,102, filed on Nov. 3, 2017.

(51) Int. Cl. B62H 1/12; B62J 27/00

(52) U.S. Cl. CPC B62H 1/12; B62J 27/00

(57) ABSTRACT

A motorcycle safety and training device that selectively restricts the maximal effective height of a motorcycle's front wheel above the ground. The device generally comprises a lightweight, adjustable bracket assembly that may be affixed to a rear suspension swingarm of a motorcycle, and one or more preferably pneumatic wheels located at or near the free end of the assembly. When the device is affixed to a swingarm, the assembly extends generally rearward beyond the rear wheel of the motorcycle in one of a variety of selected positions, and during use the device moves in conjunction with the swingarm relative to the suspended chassis of the motorcycle.

### TECHNICAL FIELD

The presently described subject matter relates generally to a safety devices for motorcycles, and in particular to safety and training devices that selectively restrict the maximal effective height of a motorcycle's front wheel above the ground during a wheelie.

### BACKGROUND

Numerous attempts have been made to provide devices that can be affixed to or form part of a motorcycle or bicycle so as to stabilize it during a wheelie maneuver. In a wheelie maneuver, a rider rotates the motorcycle or bicycle upwards and backwards about its rear wheel axle, and balances it on the rear wheel while maintaining linear forward motion. If this rotation of the motorcycle or bicycle is allowed to progress too far beyond the balance point and into an over-rotated condition (i.e. in which the center of gravity of the rider/cycle combination extends backwards past the rear wheel axle), the stability of the motorcycle or bicycle may become unrecoverable and result in a fall. Wheelie safety devices accordingly seek to prevent such over-rotation, and generally accomplish this objective by providing a ground contact member on a structure that extends rearwardly from the motorcycle or bicycle.

By way of example, U.S. Pat. No. 8,075,011 describes a device for sport configured motorcycles that restricts the angular inclination of the motorcycle, and in which a frame assembly trails behind the rear wheel of the motorcycle on pavement engaging secondary support wheels. U.S. Pat. No. 6,149,179 describes a wheelie stabilizer and safety device in which a pivotable arm assembly extends rearwardly from a spring-urged mounting bracket that is attached to the rear axle of a bicycle. U.S. Pat. No. 4,153,268 describes a cycle stabilization accessory for bicycles that includes a pair of telescopically adjustable arms secured to the structure of the bicycle and extending rearwardly to a wheel assembly carried at their free end.

A 2013 study by Virginia Tech reveals that close to 30% of motorcycle riders did not attend any prior motorcycle training; they simply taught themselves. Around 73% of the respondents in the study indicated that they have been involved in a crash, and 63% state that it was purely due to rider error.

### SUMMARY

In embodiments of the presently described subject matter, there is provided a motorcycle safety and training device that selectively restricts the maximal effective height of a motorcycle's front wheel above the ground. The device generally comprises a lightweight, adjustable bracket assembly that may be affixed to a rear suspension swingarm of a motorcycle, and one or more preferably pneumatic wheels located at or near the free end of the assembly. When the device is affixed to a swingarm, the assembly extends generally rearward beyond the rear wheel of the motorcycle in one of a variety of selected positions, and during use the device moves in conjunction with the swingarm (relative to the suspended chassis of the motorcycle).

The device may comprise a main arm that is affixed at one end to the motorcycle swingarm by means of one or more mounting plates and associated fasteners, and a pivot arm that is pivotally attached to the main arm at the opposite end thereof. As described in further detail below, the main arm of the assembly extends longitudinally rearwardly, generally in line with and preferably upwardly relative to the swingarm, and the pivot arms of the assembly may be secured in one of several positions relative to the main arm to permit rotation of the motorcycle up to a desired maximum angular inclination and effective front wheel height, or in a stowed position for transport/storage (or when desired to keep the assembly out of the way of branches, etc. while riding in dense bush). The axis about which pivot arms of the assembly pivots relative to the main arm of the assembly is generally perpendicular to the longitudinal axis (and thus the direction of travel) of the motorcycle.

The one or more wheels of the device are located at or adjacent the free end of the pivot arm, and the pivot arm may further include an inward reverse bend or kink in order to bring the wheel(s) of the device generally into alignment with the rear wheel of the motorcycle. In some embodiments, the pivot arm may be constructed of a plurality of elements that telescope relative to one another in order to selectively shorten or lengthen the pivot arm, and/or to change the offset of the device wheel(s) relative to the rear wheel of the motorcycle. In some embodiments, the pivot arm may comprise a primary pivot arm and an auxiliary pivot arm, wherein the primary and auxiliary pivot arms are secured together at or near their free ends, and are both pivotally connected to the main arm, but on opposite lateral sides thereof so as to “sandwich” the main arm and thus provide additional lateral strength. In some such embodiments, the auxiliary pivot arm may be shorter than the primary pivot arm so as to save weight; alternatively, the auxiliary pivot arm may extend the full length of the primary pivot arm.

In preferred embodiments, the main arm and the pivot arm elements of the device are cut or constructed from 6061 aluminum sheeting, and connected together with conventional fasteners such as grade 8 stainless steel threaded bolts and nuts. Such construction not only simplifies manufacture and assembly of the device, but also ensures that the device is sufficiently lightweight as to have no appreciable negative effect on the handling or performance of the motorcycle to which it is affixed, even if the motorcycle is itself relatively lightweight (e.g. a motocross or trail bike). The wheels of the device preferably include pneumatic tires that can provide more or less cushioning as desired for a given application, depending upon inflation pressure.

The presently disclosed wheelie guard is primarily a safety device whose features enable riders of all experience levels to improve essential motorcycle riding skills (e.g. throttle & brake control; balance & body positioning) in a safe environment that reduces the risk of injury, whilst still providing the opportunity for a selected maximum amount of “rider error” in order to enhance learning. The wheelie guard accordingly has applications in a variety of aspects of motorcycling, including general riding safety, training and competition.

In the context of general riding safety, the wheelie guard can be used by beginner riders on a daily basis on both tarmac and gravel roads (thanks to its single sided design, adjustable settings and inflatable tires) to avoid the consequences of a common error known as a “whiskey throttle”, in which a sudden twist of the throttle causes an over-rotation of the motorcycle and typically sends the rider onto his/her back with the motorcycle more often than not landing on top of them. Common factors that precipitate this scenario include: a general lack of riding experience; underestimation of the power of the motorcycle engine; overestimation by the rider of their riding abilities; and incorrect hand position on the throttle during certain maneuvers. However, if the wheelie guard is set to permit only a small amount of rotation, the maximum height of the front wheel is restricted no matter how much power/throttle has been applied, and the front wheel is easily diverted back to the ground where the rider has the greatest chances of regaining control of the motorcycle.

In the context of training how to perform a wheelie, the wheelie guard may be adjusted at several different settings (each permitting a different amount of wheel lift and rotation), thereby enabling a rider to set a maximum front wheel height consistent with their current comfort level. Anything over the desired height/rotation is restricted by the device. Once the rider has become comfortable with beginner settings, they can move on to intermediate settings to continue practicing balance, throttle, and brake control. With time and practice, the rider finally moves up to the expert settings at which the device permits rotation up to (and in some settings also slightly beyond) the balance point, and restricts only severe over-rotation of the motorcycle. During this process, the rider is enhancing his reaction response time, bike control, maneuverability, and many other techniques to become almost “second nature”. A much faster response time and enhanced motorcycle control provides the rider with significantly higher chances of successfully avoiding sudden dangerous situations.

The wheelie guard also has applications in the context of competitive sports, including motocross, enduro, trail riding, and stunting disciplines. Use of the wheelie guard in a competitive sport context may: (a) provide mental confidence to an athlete by ensuring that their motorcycle will not over-rotate and thus allow them to push their limits; (b) provide stability when training on obstacles such as rocks, tree longs, hill climbs, motocross track “whoops” and many other obstacles that racers are expected to ride over in the shortest time possible; and (c) facilitate the practicing of “race starts” where as much throttle as possible should be applied without allowing the back wheel to spin and the front wheel to lift. Motorcycle over-rotation due to the application of too much power is a major safety concern while practicing this race technique if the wheelie guard is not used.

### BRIEF DESCRIPTION OF THE DRAWINGS:

For a fuller understanding of the nature and advantages of the disclosed subject matter, as well as the preferred modes of use thereof, reference should be made to the following detailed description, read in conjunction with the accompanying drawings. In the drawings, like reference numerals designate like or similar steps or parts.

FIG. 1 is a schematic top plan view of a wheelie guard in accordance with one embodiment of the presently described subject matter.

FIG. 2 is a schematic perspective view of the bracket assembly of the wheelie guard of FIG. 1.

FIG. 3 is an exploded schematic view of the assembly of FIG. 2.

FIG. 4 is an exploded schematic view of the assembly of FIG. 2, showing the location and size of the bores drilled therethrough.

FIG. 5 is a schematic perspective view of the fasteners of the wheelie guard of FIG. 1.

FIG. 6 is a rear perspective photograph of a wheelie guard in accordance with a further embodiment of the presently described subject matter.

FIG. 7 is a perspective view of a wheelie guard in accordance with a further embodiment of the presently described subject matter, showing the pivot arm thereof in a stowed position.

FIG. 8 is a perspective view of a wheelie guard of FIG. 7, showing the pivot arm thereof in a representative riding position.

FIGS. 9A and 9B are side elevation views of a wheelie guard in accordance with a further embodiment of the presently described subject matter, showing the pivot arm in two riding positions and one stowed position, respectively.

FIG. 10 is a schematic perspective view of a wheelie guard in accordance with a further embodiment of the presently described subject matter.

FIG. 11 is a schematic exploded top plan view of the wheelie guard of FIG. 10.

FIG. 12 is a schematic exploded rear end view of the wheelie guard of FIG. 10.

FIG. 13 is a schematic left side view of the wheelie guard of FIG. 10.

FIG. 14 is a schematic right side view of the wheelie guard of FIG. 10, showing the pivot arm in two riding positions and one stowed position, respectively.

FIG. 15 is a schematic exploded rear perspective view of the wheelie guard of FIG. 10.

### DESCRIPTION OF SPECIFIC EMBODIMENTS

The following description of preferred embodiments is merely exemplary in nature and is in no way intended to limit the invention, its application, or uses. The wheelie guard of the present invention may take form in a number of different embodiments depending upon the particular requirements of the use.

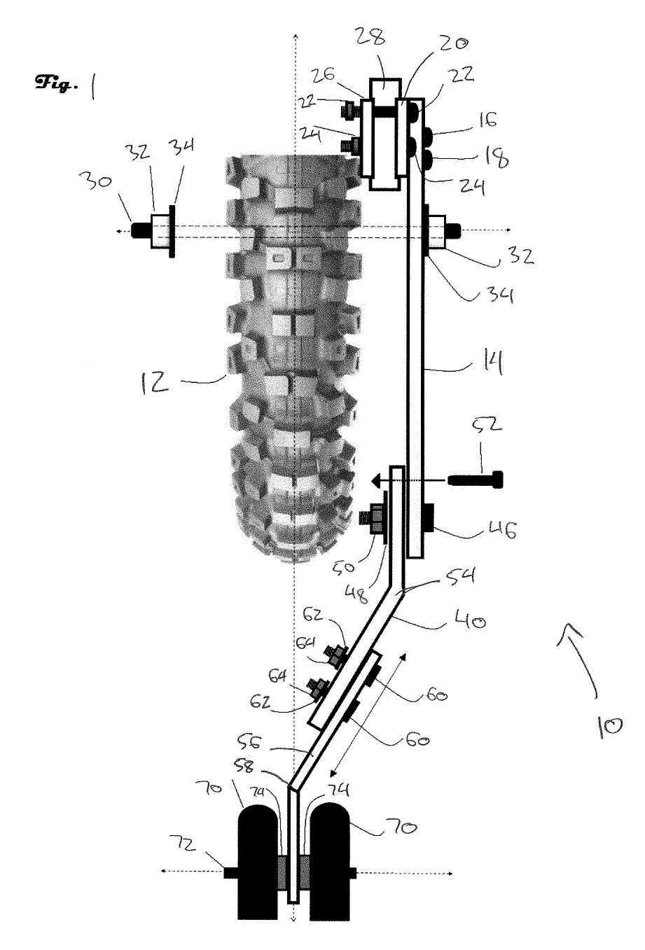

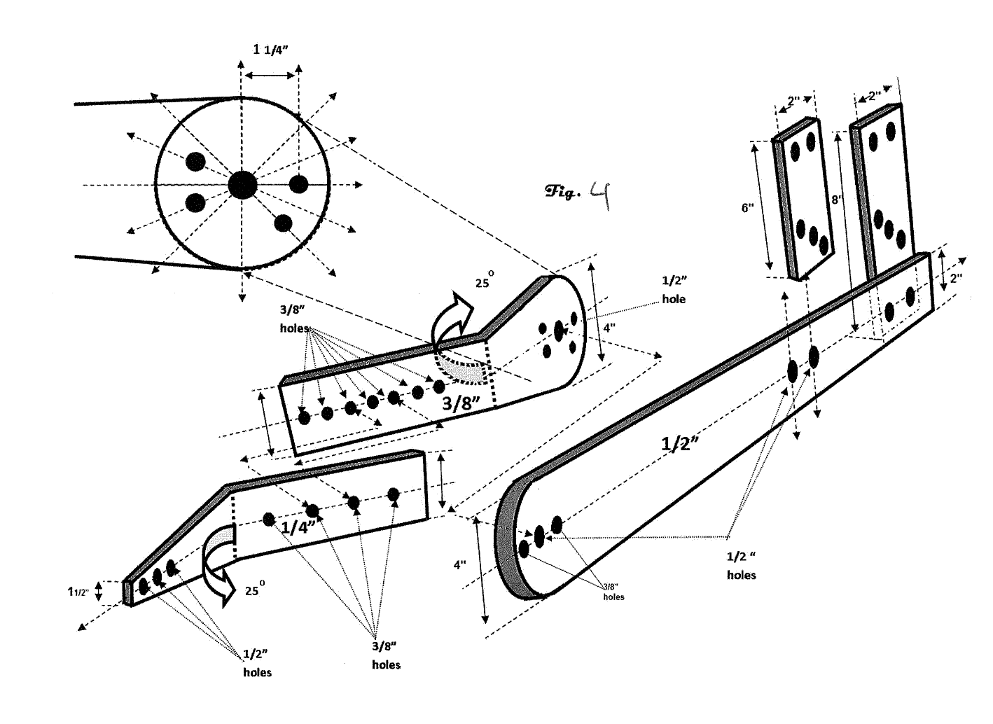

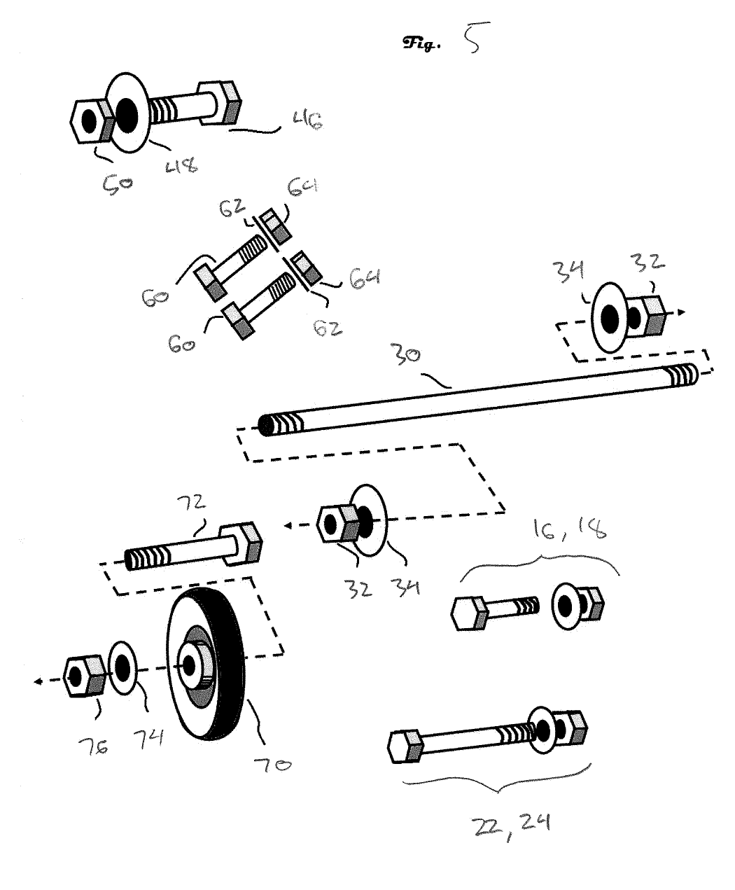

With reference to FIGS. 1-5, there is illustrated one embodiment of a wheelie guard in accordance with the presently described subject matter. The wheelie guard 10 is shown in FIG. 1 in juxtaposition to a representative rear motorcycle wheel 12, and comprises main arm 14 affixed at a first end via fasteners 16, 18 (each comprising conventional threaded bolts, nuts and washers) to a first mounting plate 20, which in turn is connected via fasteners 22, 24 (each again comprising conventional threaded bolts, nuts and washers) to second mounting plate 26 and secured around (i.e. with plates 20, 26 on either side of, and fasteners 22, 24 above and below, respectively) a rear suspension swingarm 28 of a motorcycle. Also connecting main arm 14 to swingarm 28 is a threaded rod 30 extending through the hollow axle of rear motorcycle wheel 12 and secured at either end with nuts 32 and washers 34.

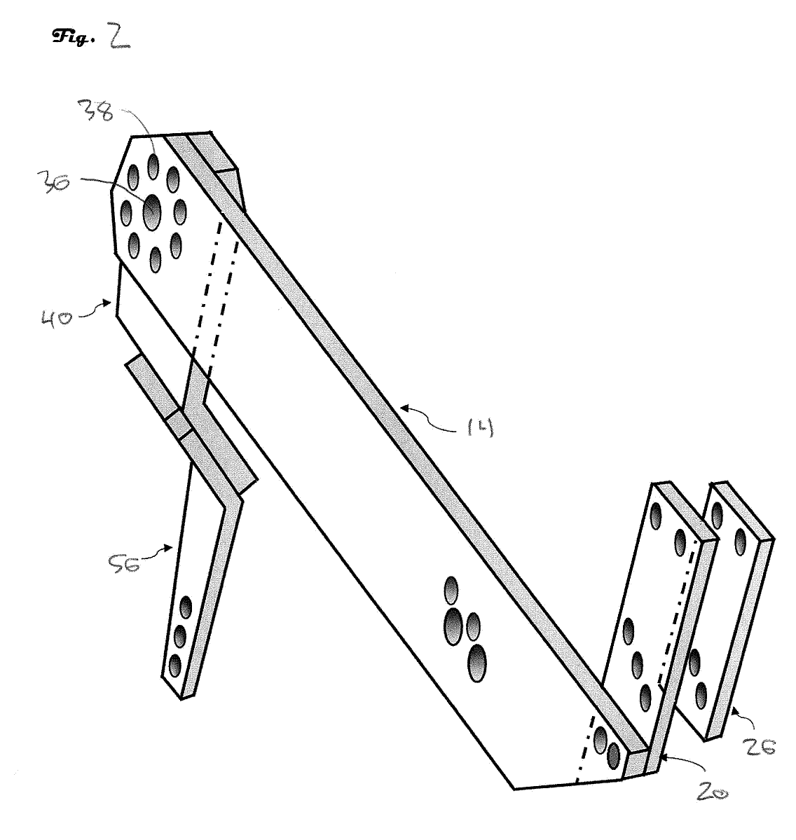

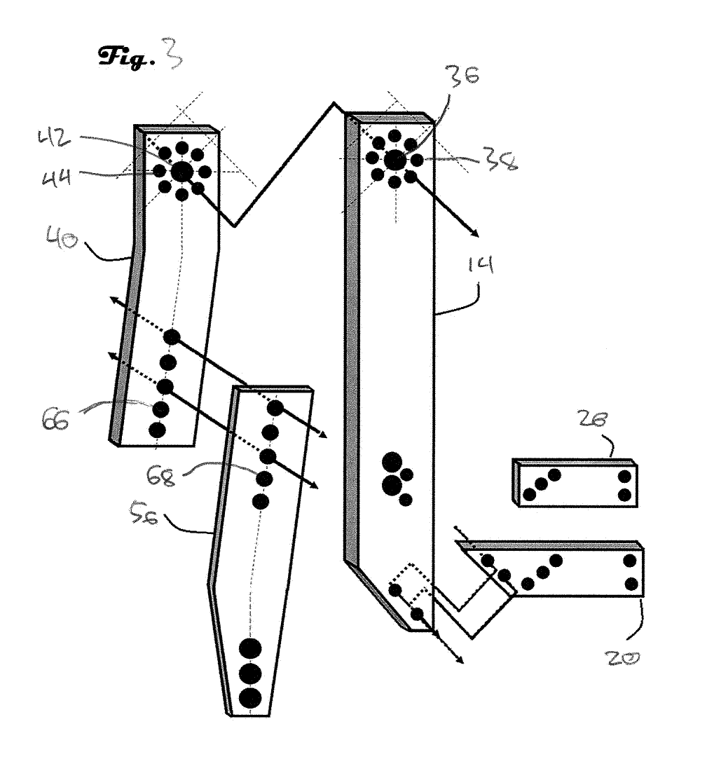

As best seen in FIG. 2, a pivot and pin apparatus comprising a central bore 36 surrounded by a plurality of bores 38 situated in a planetary arrangement around central bore 36 is provided at the second, opposite end of main arm 14 for the pivotal connection of main arm 14 to a pivot arm 40. As best seen in FIG. 3, a corresponding central bore 42 and planetary bores 44 are provided in pivot arm 40. Returning now to FIG. 1, a bolt 46 is passed through central bores 36, 42 and secured at the other end with washer 48 and nut 50, and the angular position of pivot arm 40 relative to main arm 14 is secured by at least one pin 52 passed and secured through bores 38, 44.

Pivot arm 40 includes a roughly 25° inward bend 54 and an extender element 56 with a roughly 25° outward bend 58. Pivot arm 40 and extender element 56 are connected together by conventional fasteners such as bolts 60, washers 62 and nuts 64 passed through bores 66, 68. As best seen in FIG. 3, a plurality of bores 66, 68 are provided in each of pivot arm 40 and extender element 56 to permit the telescopic extension or retraction of extender element 56 relative to pivot arm 40, thereby to selectively shorten or lengthen the overall length of the pivot arm, and/or to change the offset of the pneumatic wheels 70 of the device relative to the rear wheel 12 of the motorcycle. A pair of pneumatic wheels 70 are located at the free end of extender element 56 and secured thereto by conventional fasteners such as threaded bolts 72, washers 74 and nuts 76.

Each of main arm 14, pivot arm 40 and extender element 56 may include multiple alternative bores (i.e. like bores 66 of the pivot arm 40 and bores 68 of the extender element 56) for each of the connections described above in order to permit desired adjustments and to accommodate motorcycle swingarms of different sizes, and are preferably formed from 6061 aluminum sheeting. All fasteners of the embodiment of FIGS. 1-5 are preferably formed of grade 8 stainless steel threaded bolts and nuts. Such construction not only simplifies manufacture and assembly of the device, but also ensures that the device is sufficiently lightweight as to have no appreciable negative effect on the handling or performance of the motorcycle to which it is affixed, even if the motorcycle is itself relatively lightweight. Pneumatic wheels 70 may provide more or less cushioning as desired for a given application, depending upon inflation pressure.

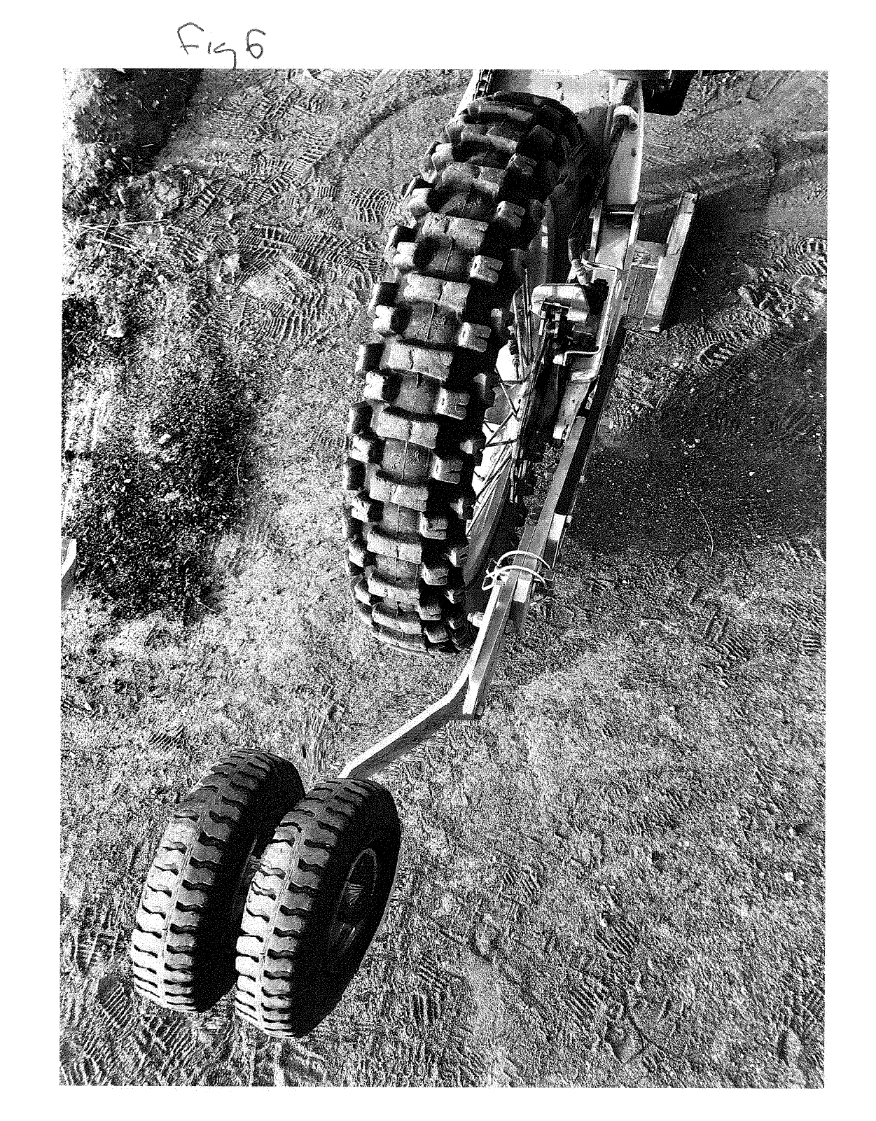

FIG. 6 illustrates an alternative embodiment of a wheelie guard 80 in which the length of the pivot arm is adjustable, but the offset of the device wheels relative to the rear wheel of the motorcycle is not. In this embodiment, the pivot arm is straight, and extender element includes reverse 25° inward and 25° outward bends.

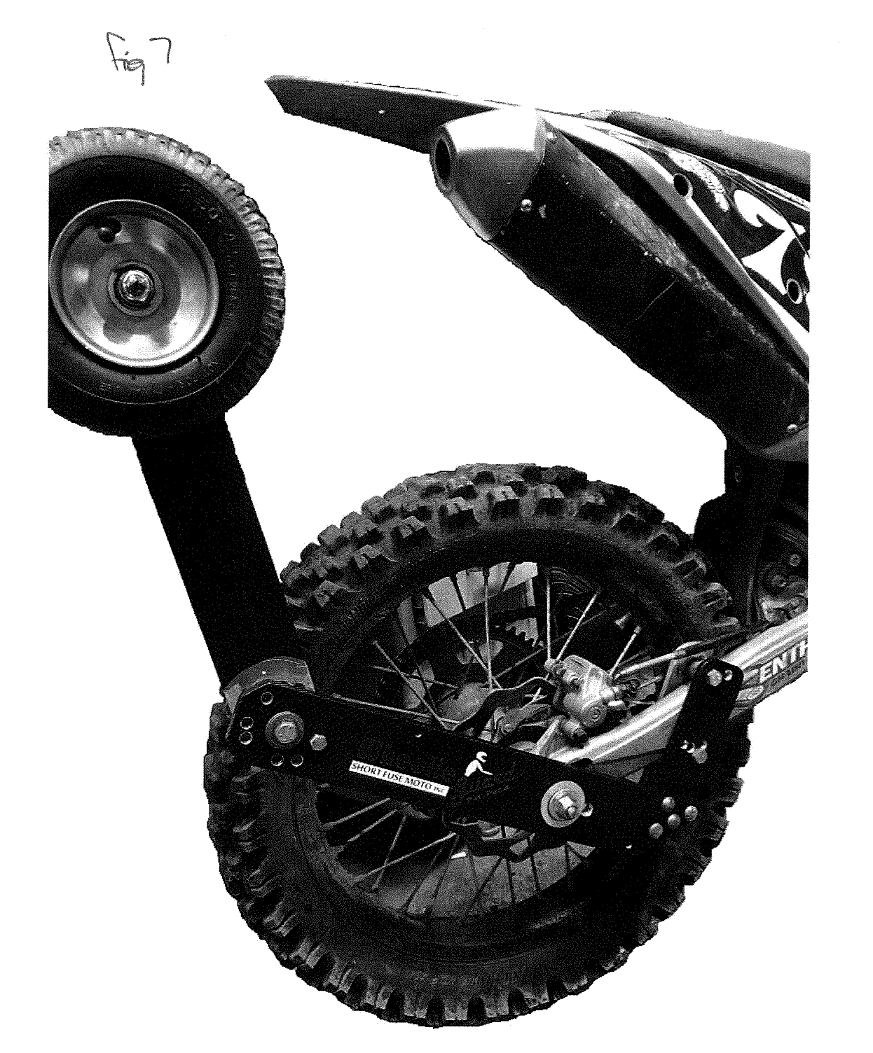

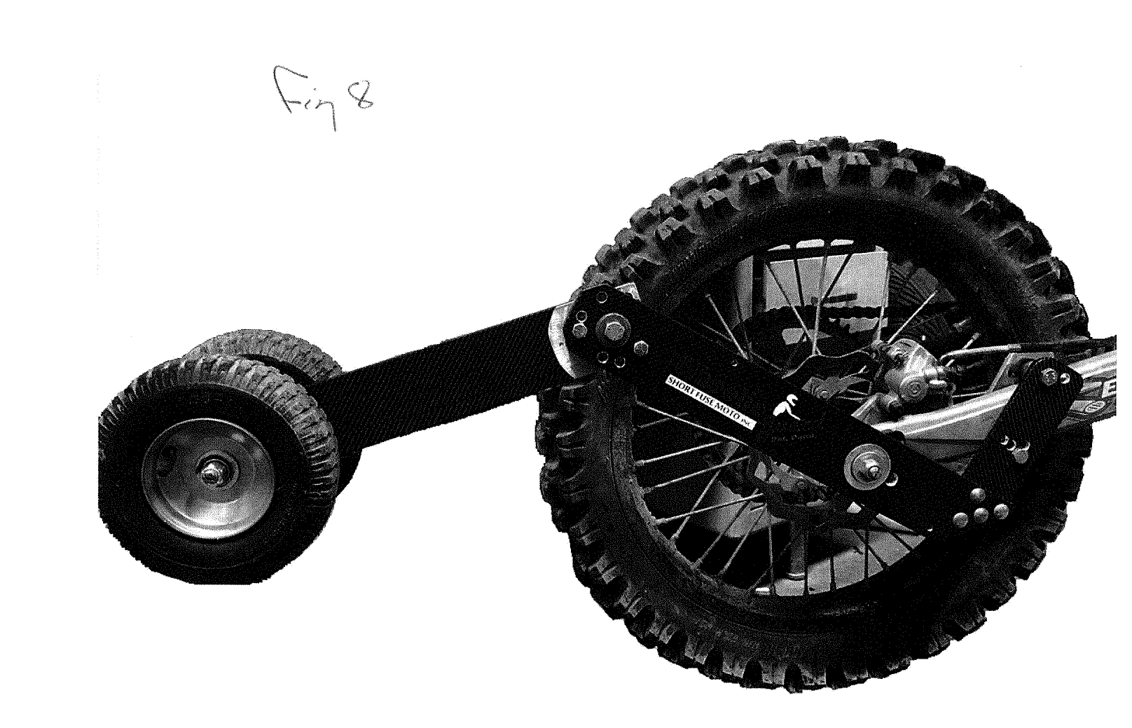

FIGS. 7 illustrates a further alternative embodiment of a wheelie guard 85 in a stowed position, and FIG. 8 illustrates this same embodiment in one of a plurality of riding positions.

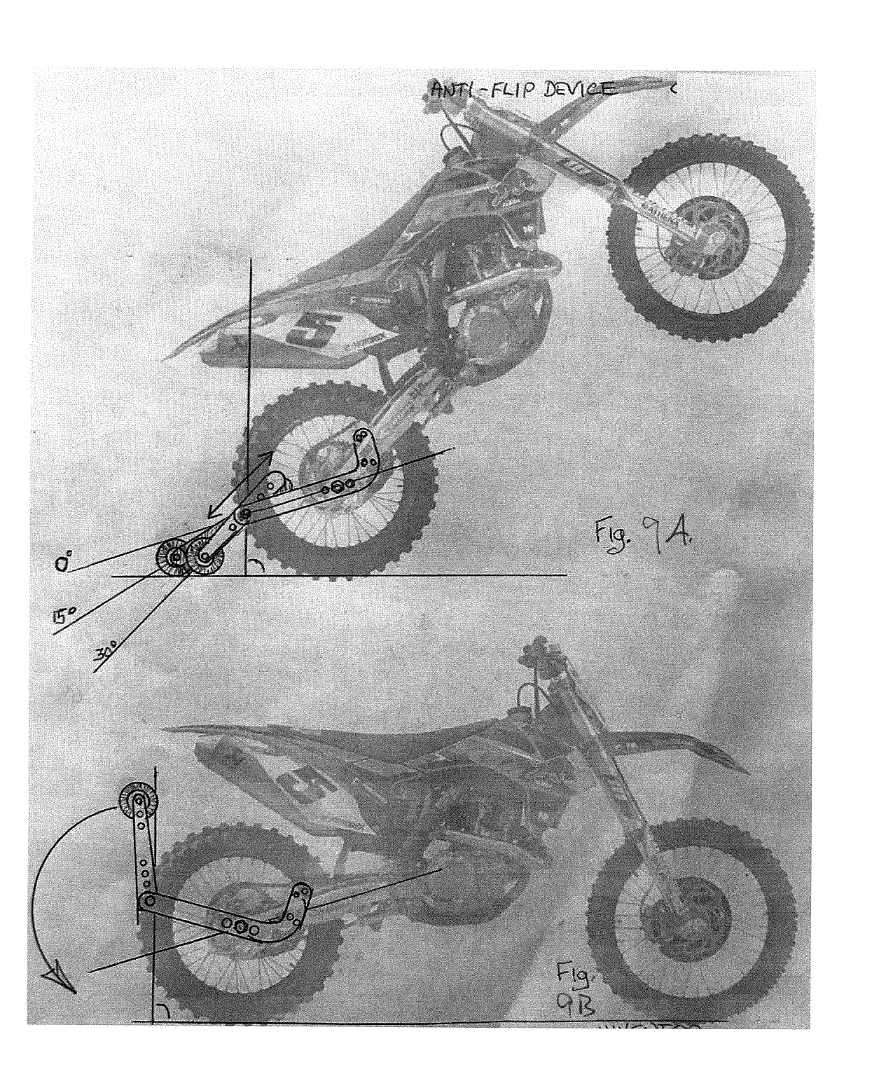

FIGS. 9A and 9B illustrate a yet further alternative embodiment of a wheelie guard 90 in combination with a representative motorcycle. FIG. 9A shows the wheelie guard in alternative 0° (“advanced”), 15° (“intermediate”) and 30° (“beginner”) riding positions, and FIG. 9B shows the same embodiment in a stowed position.

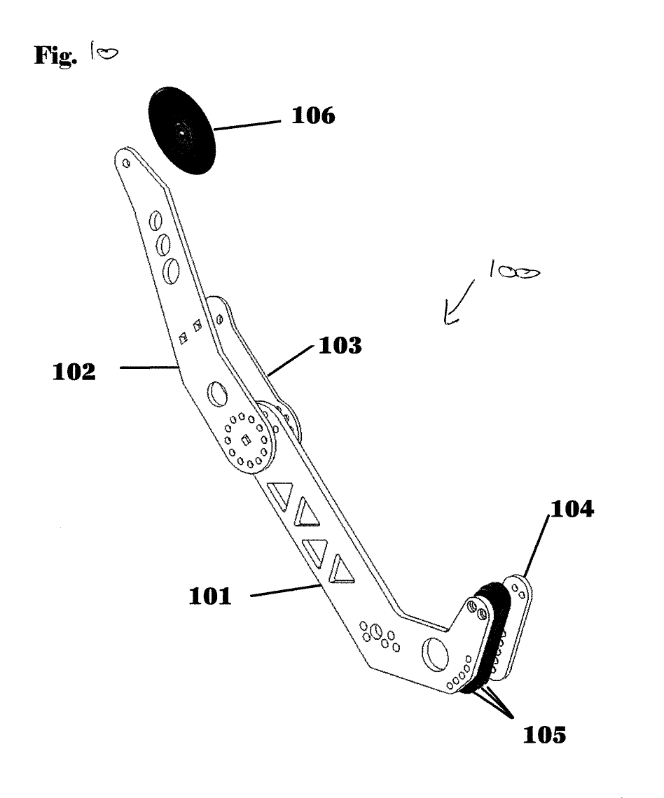

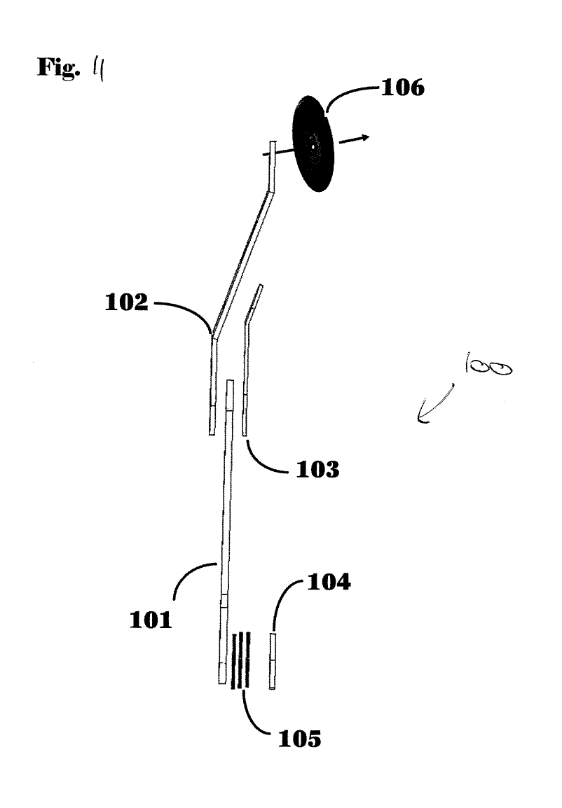

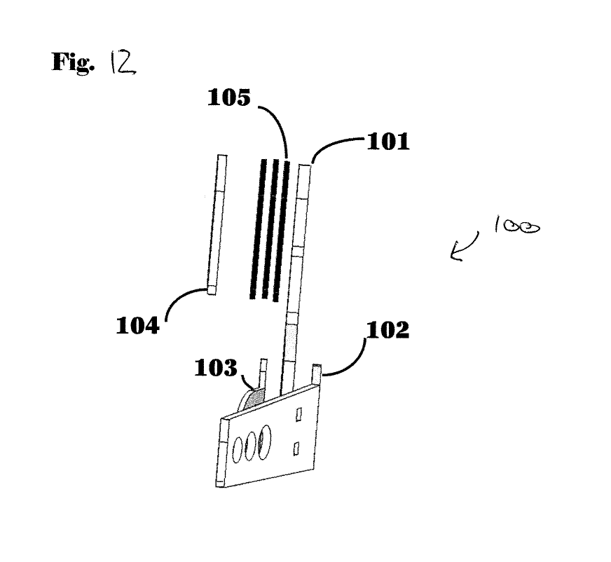

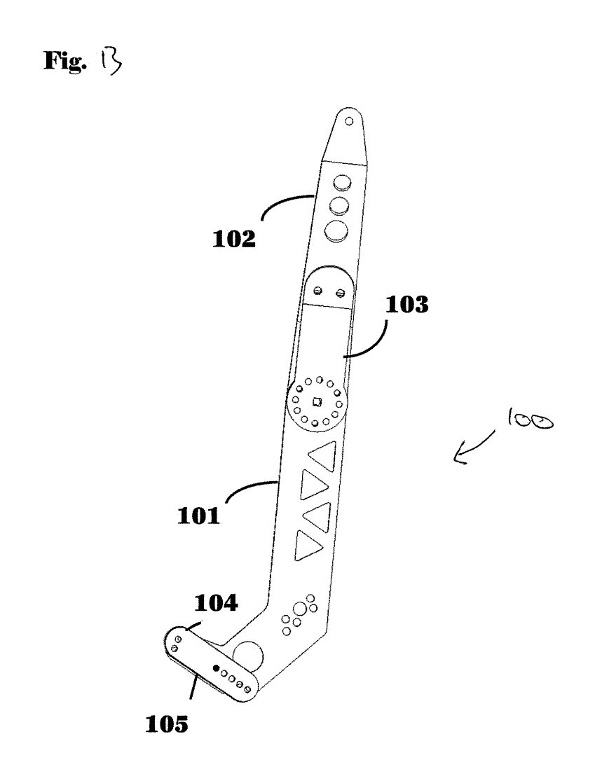

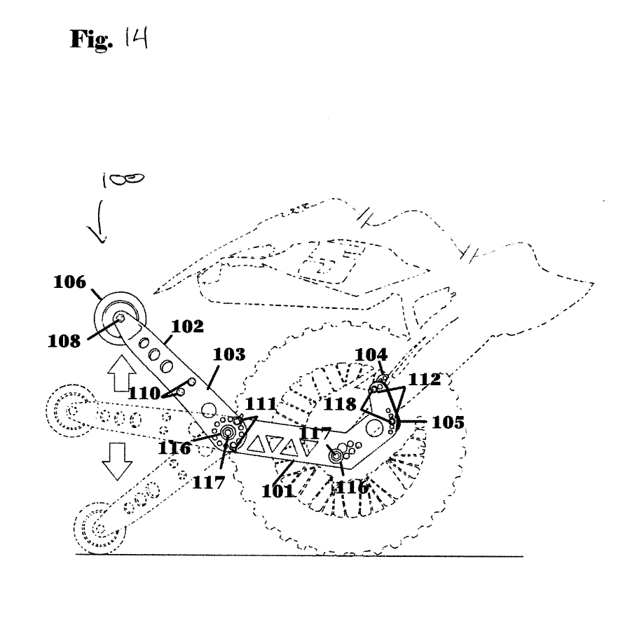

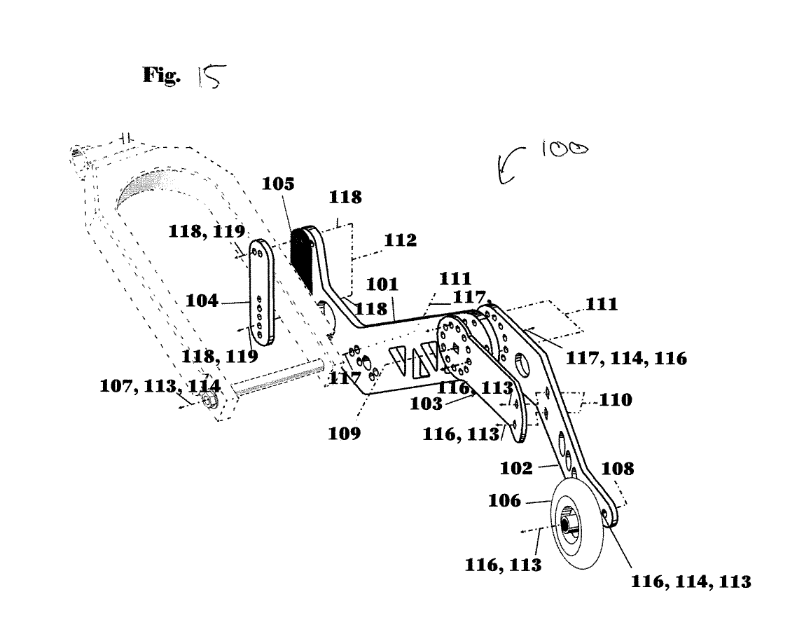

FIGS. 10 to 15 illustrate a preferred further embodiment of a wheelie guard 100, which comprises many of the same components of wheelie guards 10, 80, 85 and 90 illustrated and described with reference to FIGS. 1-9. However, in wheelie guard 100, the pivot arm comprises a primary pivot arm 102 and an auxiliary pivot arm 103, and main arm 101 is configured for attachment (via conventional threaded bolts, nuts and washers) around the rear suspension swingarm of a motorcycle to clamp bar 104, thereby eliminating the requirement for a first mounting plate such as first mounting plate 20 of FIGS. 1-5. One or more rubber spacers 105, preferably constructed of EPDM, are fitted between main arm 101 and the motorcycle swingarm. As illustrated in FIGS. 10-15, wheelie guard 100 comprises main arm 101, primary pivot arm 102, auxiliary pivot arm 103, clamp bar 104, rubber spacers 105, pneumatic wheel 106, axle through bolt 107, wheel bolt 108, pivot bolts 109, joining bolts 110, height adjustment pins 111, clamp bolts 112, washers 113, lock washers 114, nuts 115, Ny-Lock™ nuts 116, large washers 117, washers 118, and Ny-Lock™ nuts 118.

The present description is of the best presently contemplated mode of carrying out the subject matter disclosed herein. The description is made for the purpose of illustrating the general principles of the subject matter and not to be taken in a limiting sense; the described subject matter can find utility in a variety of implementations without departing from the scope of the invention made, as will be apparent to those of skill in the art from an understanding of the principles that underlie the invention.

We claim:

1. A wheelie guard comprising: a main arm configured at a first end for attachment via conventional fasteners to a rear suspension swingarm of a motorcycle; and a pivot arm pivotally connected to the opposite second end of the main arm, the pivot arm comprising a wheel assembly at the free end thereof; wherein the pivotal attachment between the main arm and the pivot arm comprises means for securing the pivot arm at one of a selected number of different angular positions relative to the main arm.

2. The wheelie guard of claim 1, wherein the pivot arm comprises a primary pivot arm and an auxiliary pivot arm.
